(19) United States
(12) Patent Application Publication
(10) Pub. No.: US 2019/0170713 A1
(43) Pub. Date: Jun. 6, 2019

(54) THIN LAYER CHROMATOGRAPHY PLATE AND SAMPLE ANALYSIS METHOD USING SAME

(71) Applicant: Panasonic Intellectual Property Management Co., Ltd., Osaka (JP)

(72) Inventors: TOSHIHIRO SAKAMOTO, Osaka (JP); TOSHINOBU MATSUNO, Kyoto (JP)

(21) Appl. No.: 16/321,200

(22) PCT Filed: Dec. 6, 2017
(86) PCT No.: PCT/JP2017/043720

§ 371 Date: Jan. 28, 2019

(30) Foreign Application Priority Data
Dec. 26, 2016 (JP) 2016-250757
Dec. 26, 2016 (JP) 2016-250758

(51) Int. Cl. G01N 30/92; G01N 30/91; G01N 30/94

(52) U.S. Cl. CPC G01N 30/92; G01N 30/94; G01N 30/91

(57) ABSTRACT

The thin layer chromatography plate includes a substrate and a separation layer. The separation layer is disposed on the substrate and is configured to separate multiple components included in a sample from each other. The separation layer includes a first layer and a second layer. The first layer has a porous structure and extends in a first direction. The second layer has a porous structure and extends in the first direction. The first layer and the second layer are arrayed in a second direction orthogonal to the first direction. A zeta potential of the first layer is different from a zeta potential of the second layer.

### TECHNICAL FIELD

The present disclosure relates to a thin layer chromatography plate and a sample analysis method using the same.

### BACKGROUND

Chromatography and electrophoresis, for example, have been known as a method for separating a specific component from a mixture containing multiple components. Thin layer chromatography, which is a kind of chromatography techniques, makes it possible to easily and quickly separate multiple components from each other.

As shown in FIG. 7, PTL 1 discloses thin layer chromatography plate 500 provided with first separating agent layer 531 and second separating agent layer 532. Second separating agent layer 532 is adjacent to first separating agent layer 531. First separating agent layer 531 and second separating agent layer 532 are respectively formed from separating agents having different optical responses from each other.

When thin layer chromatography plate 500 is used, multiple components can be separated from each other as described below. Sample 560 is placed on first separating agent layer 531 and developed in direction X. Then, second separating agent layer 532 is dried. Next, the orientation of thin layer chromatography plate 500 is changed, and sample 560 is developed in direction Y orthogonal to direction X. The multiple components are separated from each other in second separating agent layer 532.

### CITATION LIST

### Patent Literature

PTL 1: International Publication No. WO 2011/149041

### SUMMARY

A thin layer chromatography plate according to a first aspect of the present disclosure includes a substrate and a separation layer. The separation layer is disposed on the substrate and configured to separate multiple components included in a sample from each other. In addition, the separation layer includes a first layer and a second layer. The first layer has a porous structure and extends in a first direction. The second layer has a porous structure and extends in the first direction. The first layer and the second layer are arrayed in a second direction orthogonal to the first direction. A zeta potential of the first layer is different from a zeta potential of the second layer.

A sample analysis method according to a second aspect of the present disclosure includes the following steps. A sample is placed onto each of the first layer and the second layer of the thin layer chromatography plate according to the first aspect. Each of ends of the first layer and the second layer in the first direction is brought into contact with a developing solvent.

According to the thin layer chromatography plate in the present disclosure and a sample analysis method using the same, a sample can be analyzed more easily and more quickly.

### BRIEF DESCRIPTION OF DRAWINGS

FIG. 1A is a plan view illustrating a thin layer chromatography plate according to a first exemplary embodiment.

FIG. 1B is a sectional view illustrating the thin layer chromatography plate shown in FIG. 1A along line IB-IB.

FIG. 2A is a partially enlarged sectional view illustrating the thin layer chromatography plate according to the first exemplary embodiment.

FIG. 2B is a partially enlarged sectional view illustrating a thin layer chromatography plate according to a modification of the first exemplary embodiment.

FIG. 2C is a partially enlarged sectional view illustrating a thin layer chromatography plate according to another modification of the first exemplary embodiment.

FIG. 3A is a schematic view showing a state where a sample is placed on the thin layer chromatography plate according to the first exemplary embodiment.

FIG. 3B is a schematic view showing a state where the thin layer chromatography plate shown in FIG. 3A is brought into contact with a developing solvent.

FIG. 4A is a plan view illustrating a thin layer chromatography plate according to a second exemplary embodiment.

FIG. 4B is a sectional view illustrating the thin layer chromatography plate shown in FIG. 4A along line IVB-IVB.

FIG. 5A is a plan view illustrating a thin layer chromatography plate according to a third exemplary embodiment.

FIG. 5B is a sectional view illustrating the thin layer chromatography plate shown in FIG. 5A along line VB-VB.

FIG. 6A is a plan view illustrating a thin layer chromatography plate according to a fourth exemplary embodiment.

FIG. 6B is a sectional view illustrating the thin layer chromatography plate shown in FIG. 6A along line VIB-VIB.

FIG. 7 is a plan view illustrating a conventional thin layer chromatography plate.

### DESCRIPTION OF EMBODIMENTS

According to the method disclosed in PTL 1, it is necessary that, after a sample is developed in first separating agent layer 531, the orientation of thin layer chromatography plate 500 is changed and the sample is developed in second separating agent layer 532. The present disclosure provides a technique for analyzing a sample more easily and more quickly.

### (Underlying Knowledge of the Present Disclosure)

A condition of human skin can be checked by analyzing proteins included in the human skin. The protein analysis is conducted in the manner described below, for example. A sample such as an epiderm is extracted from a skin of an examinee. The sample includes multiple kind of proteins. The multiple kind of proteins included in the sample are separated from each other using thin layer chromatography. Each of the separated proteins is identified.

For example, if the sample includes a protein caused by rough skin, it is found that the examinee has rough skin. If it is possible to recognize a condition of the skin of the examinee, cosmetics suitable for the examinee can be recommended. It is convenient to check the condition of the skin of the examinee and recommend cosmetics based on the check result in cosmetics retail stores. When doing so, protein analysis needs to be quickly conducted during a waiting time of the examinee.

The thin layer chromatography plate according to the present disclosure includes a substrate and a separation layer. The separation layer is disposed on the substrate and configured to separate multiple components included in a sample from each other. In addition, the separation layer includes a first layer and a second layer. The first layer has a porous structure and extends in a first direction. The second layer has a porous structure and extends in the first direction. The first layer and the second layer are arrayed in a second direction orthogonal to the first direction. A zeta potential of the first layer is different from a zeta potential of the second layer.

According to the present disclosure, the zeta potential of the first layer is different from the zeta potential of the second layer, whereby an interaction between the multiple components included in the sample and the first layer is different from an interaction between the multiple components and the second layer. Therefore, when the multiple components are developed in the first layer and the second layer, different results can be obtained in the first layer and the second layer. For example, the multiple components which are not separated from each other in the first layer are separated from each other in the second layer. The multiple components which are not separated from each other in the second layer are separated from each other in the first layer. Therefore, each of the multiple components can be identified based on the development result of the multiple components in a first stage, which eliminates a need to develop the multiple components in a second stage. Thus, the sample can be analyzed more easily and more quickly.

The thin layer chromatography plate described above may be configured such that the first layer includes a first metal oxide, the second layer includes a second metal oxide, and the first metal oxide has an isoelectric point different from an isoelectric point of the second metal oxide, for example. With this configuration, the zeta potential of the first layer can be different from the zeta potential of the second layer. Further, only the second layer among the first layer and the second layer may has the porous structure modified with a metal oxide. With this configuration, the zeta potential of the first layer can be different from the zeta potential of the second layer.

In addition, the first metal oxide in the thin layer chromatography plate is disposed on the porous structure of the first layer, for example. With this configuration, the interaction between the multiple components included in the sample and the first layer is accelerated. Thus, the multiple components may be easily separated from each other in the first layer.

In addition, the first layer of the thin layer chromatography plate includes a first metal oxide film disposed on the porous structure of the first layer. And the first metal oxide film is made of the first metal oxide, for example. With this configuration, the interaction between the multiple components included in the sample and the first layer is accelerated. Thus, the multiple components may be easily separated from each other in the first layer.

In addition, the porous structure of the first layer of the thin layer chromatography plate includes an aggregate of particles coated with a first metal oxide film. And the first metal oxide film is made of the first metal oxide, for example. With this configuration, the interaction between the multiple components included in the sample and the first layer is accelerated. Thus, the multiple components may be easily separated from each other in the first layer.

Further, the second metal oxide of the thin layer chromatography plate is disposed on the porous structure of the second layer, for example. With this configuration, the interaction between the multiple components included in the sample and the second layer is accelerated. Thus, the multiple components may be easily separated from each other in the second layer.

In addition, the second layer of the thin layer chromatography plate includes a second metal oxide film disposed on the porous structure of the second layer. And the second metal oxide film is made of the second metal oxide, for example. With this configuration, the interaction between the multiple components included in the sample and the second layer is accelerated. Thus, the multiple components may be easily separated from each other in the second layer.

In addition, the porous structure of the second layer of the thin layer chromatography plate includes an aggregate of particles coated with a second metal oxide film. And the second metal oxide film is made of the second metal oxide, for example. With this configuration, the interaction between the multiple components included in the sample and the second layer is accelerated. Thus, the multiple components may be easily separated from each other in the second layer.

In addition, the porous structure of the first layer of the thin layer chromatography plate includes an aggregate of particles each of which has a single composition phase, for example.

Further, the first metal oxide in the thin layer chromatography plate includes at least one selected from the group consisting of titanium oxide, aluminum oxide, tin oxide, zinc oxide, tungsten oxide, manganese oxide, nickel oxide, copper oxide, and magnesium oxide, for example. Thus, the multiple components may be easily separated from each other in the first layer.

Further, the second metal oxide in the thin layer chromatography plate includes at least one selected from the group consisting of titanium oxide, aluminum oxide, tin oxide, zinc oxide, tungsten oxide, manganese oxide, nickel oxide, copper oxide, and magnesium oxide, for example. Thus, the multiple components may be easily separated from each other in the second layer.

In addition, the first layer and the second layer of the thin layer chromatography plate are in contact with each other, for example. With this configuration, the separation layer can be easily manufactured.

In addition, the thin layer chromatography plate further includes a functional layer having a band shape. The functional layer is disposed on the separation layer and on which the sample is to be placed. The functional layer extends in the second direction, for example. Accordingly, when the sample is placed on the functional layer, the sample penetrates into the functional layer. The sample spreads all over the functional layer. The sample penetrating into the functional layer is brought into contact with the separation layer. Thus, it is unnecessary to place the sample on the separation layer several times. Accordingly, the sample can be efficiently placed on the separation layer.

The sample analysis method according to the present disclosure includes placing a sample on each of a first layer and a second layer of the thin layer chromatography plate according to the present disclosure, and bringing each of ends of the first layer and the second layer in a first direction into contact with a developing solvent.

Thus, different results can be obtained in the first layer and the second layer. For example, the multiple components which are not separated from each other in the first layer are separated from each other in the second layer. The multiple components which are not separated from each other in the second layer are separated from each other in the first layer. Therefore, each of the multiple components can be identified based on the development result of the multiple components in a first stage, which eliminates a need to develop the multiple components in a second stage. Thus, the sample can be analyzed more easily and more quickly.

Further, the developing solvent used in the sample analysis method contains water, for example. With this configuration, when the first layer and the second layer are brought into contact with the developing solvent, the first metal oxide and the second metal oxide are charged. Types of charges or amounts of charges generated in the first metal oxide and the second metal oxide are different from each other. Therefore, the interaction between the multiple components included in the sample and the first layer is greatly different from the interaction between the multiple components and the second layer. Thus, each of the multiple components can be easily identified based on the development result of the multiple components in the first stage.

In addition, the sample used in the sample analysis method includes a protein, for example. With this configuration, the interaction between the first layer or the second layer and the protein may be accelerated. Thus, the multiple components can be easily separated from each other in the first layer or the second layer.

Exemplary embodiments of the present disclosure will be described below with reference to the drawings. The present disclosure is not limited to the following exemplary embodiments.

### First Exemplary Embodiment

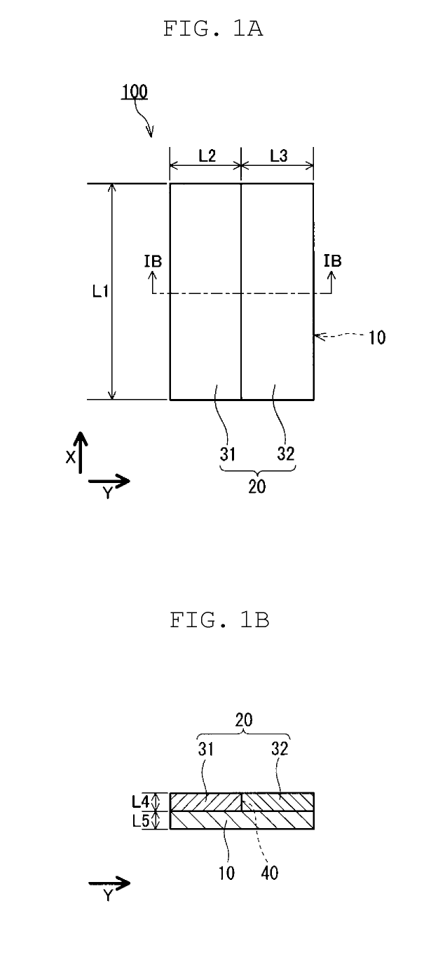

As shown in FIGS. 1A and 1B, thin layer chromatography plate 100 (hereinafter referred to as “TLC plate 100”) according to the present exemplary embodiment has substrate 10 and separation layer 20. Substrate 10 has a plate shape, for example. Substrate 10 has, for example, a rectangular shape in a plan view. Separation layer 20 is disposed on substrate 10. Separation layer 20 covers the surface of substrate 10. Substrate 10 has two pairs of end faces facing each other. In the present exemplary embodiment, development direction X (first direction) extends from one end face of one pair of the two pairs of end faces of substrate 10 to the other end face. Multiple components included in the sample are developed in development direction X. Array direction Y (second direction) extends from one end face of another pair of the two pairs of end faces of substrate 10 to the other end face and is orthogonal to development direction X.

Separation layer 20 separates the multiple components included in the sample from each other. Separation layer 20 includes first layer 31 and second layer 32. First layer 31 is a layer having a band shape. First layer 31 has a rectangular band shape in a plan view. First layer 31 extends in development direction X. First layer 31 extends from one of a pair of end faces of substrate 10 to the other in development direction X. Note that first layer 31 may not reach to the other end face of substrate 10.

Second layer 32 is a layer having a band shape. Second layer 32 has a rectangular band shape in a plan view. Second layer 32 extends in development direction X. Second layer 32 extends from one of a pair of end faces of substrate 10 to the other in development direction X. Note that second layer 32 may not reach to the other end face of substrate 10.

First layer 31 and second layer 32 are both disposed on substrate 10. In other words, first layer 31 and second layer 32 are both in contact with substrate 10. First layer 31 and second layer 32 are arrayed in array direction Y. In the present exemplary embodiment, second layer 32 is in contact with first layer 31. A side surface of first layer 31 and a side surface of second layer 32 are in contact with each other. When separation layer 20 is viewed in a plan view, one side of first layer 31 is in contact with one side of second layer 32. A length of the one side of first layer 31 is equal to a length of the one side of second layer 32. Boundary face 40 is formed due to the contact between first layer 31 and second layer 32. Boundary face 40 extends in development direction X. Note that second layer 32 may not be in contact with first layer 31.

The material of substrate 10 is not particularly limited, as long as it can maintain the shape of TLC plate 100 without being eluted in a developing solvent. The material of substrate 10 is glass, resin, metal, or paper, for example. Substrate 10 is typically a glass plate or an aluminum film.

First layer 31 has a porous structure. The porous structure of first layer 31 can carry the developing solvent from one end to the other end of first layer 31 in development direction X due to capillary force. The material of the porous structure is not particularly limited. The material of the porous structure includes at least one selected from the group consisting of a fiber material, an inorganic material, and a polymer material, for example.

The fiber material includes at least one selected from the group consisting of a plant fiber, an animal fiber, a recycled fiber, a synthetic fiber, and a glass fiber, for example. The plant fiber includes cellulose, for example. The synthetic fiber includes cellulose acetate, for example.

The inorganic material includes at least one selected from the group consisting of alumina, silicon dioxide, and zirconia, for example. The polymer material includes at least one selected from the group consisting of agarose, dextran, mannan, fluororesin, polystyrene, polyethylene, polypropylene, polyurethane, and polyvinyl chloride, for example.

The porous structure is formed from at least one selected from the group consisting of filter paper, an aggregate of inorganic particles, a porous body of a polymer material, and an aggregate of polymer material particles, for example. The inorganic particles include at least one kind selected from the group consisting of alumina particles, silica gel particles, silicon pillar, zeolite particles, diatomaceous earth, and zirconia particles, for example. The inorganic particles may be modified with a hydrophobic functional group or a hydrophilic functional group. The hydrophobic functional group includes a functional group having a hydrocarbon group at the end, for example. The hydrocarbon group includes at least one selected from the group consisting of an octadecyl group, an octyl group, a t-butyl group, a trimethylsilyl group, and a phenyl group, for example. The hydrophilic functional group includes at least one selected from the group consisting of a functional group having a cyano group and a functional group having an amino group, for example.

An average pore diameter of the porous structure of first layer 31 may range from 0.01 μm to 100 μm both inclusive. When the porous structure of first layer 31 is formed from an aggregate of inorganic particles or polymer material particles, an average particle diameter of inorganic particles or polymer material particles may range from 1 μm to 100 μm both inclusive. The “average pore diameter” can be measured with the following method. Specifically, the surface or cross-section of first layer 31 is observed with an electron microscope (for example, an electron scanning microscope). Pore diameters of a plurality of pores (for example, random 50 pores) in the observed porous structure are measured. The average pore diameter is determined based on the average value calculated using the measured values. The diameter of a circle having an area equal to the area of the pore observed with the electron microscope can be regarded as the pore diameter. The “average particle diameter” can be measured with the following method. Specifically, the surface or cross-section of first layer 31 is observed with an electron microscope, and diameters of random number (for example, 50) of particles constituting the porous structure of first layer 31 are measured. The average particle diameter is determined based on the average value calculated using the obtained measured values. The diameter of a circle having an area equal to the area of the particle observed with the electron microscope can be regarded as the particle diameter.

First layer 31 includes a first metal oxide. The first metal oxide is not particularly limited, as long as it is a metal oxide. The first metal oxide includes at least one selected from the group consisting of titanium oxide, aluminum oxide, tin oxide, zinc oxide, tungsten oxide, manganese oxide, nickel oxide, copper oxide, and magnesium oxide, for example. The first metal oxide may be a semimetal oxide. The semimetal oxide includes at least one selected from the group consisting of boron oxide and silicon dioxide, for example. The first metal oxide is different from the material of the porous structure of first layer 31. The composition of the first metal oxide is different from the composition of the porous structure of first layer 31. The first metal oxide may be included in the porous structure of first layer 31.

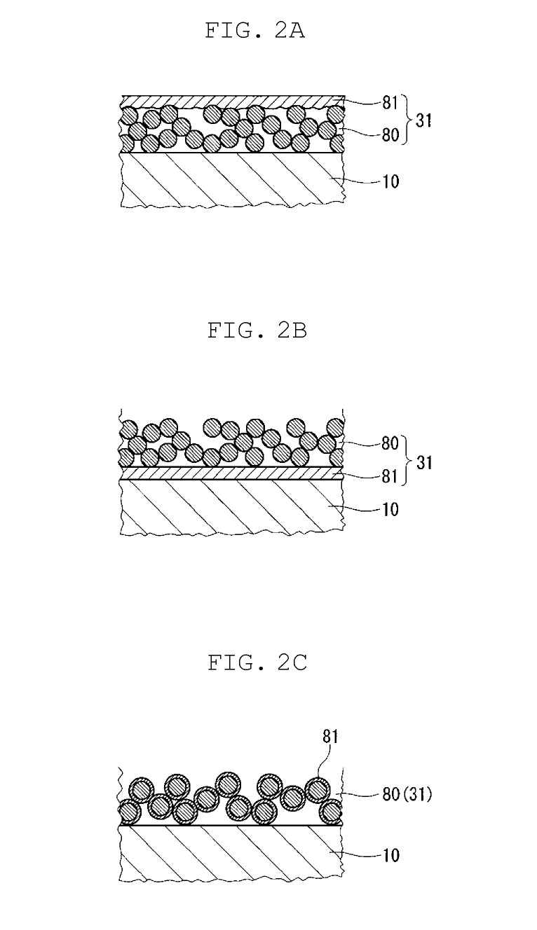

The first metal oxide may be in contact with a part of the porous structure of first layer 31. The first metal oxide may be disposed on the porous structure of first layer 31. The first metal oxide may be disposed between the porous structure of first layer 31 and substrate 10. When the porous structure of first layer 31 is formed from an aggregate of inorganic particles or polymer material particles, the first metal oxide may be located between multiple particles constituting the porous structure of first layer 31. As shown in FIG. 2A, first metal oxide film 81 may be disposed on porous structure 80 of first layer 31. First metal oxide film 81 is made of the first metal oxide. As shown in FIG. 2B, first metal oxide film 81 may be disposed between porous structure 80 of first layer 31 and substrate 10. When the first metal oxide is in contact with porous structure 80 of first layer 31, the interaction between the multiple components included in the sample and first layer 31 is accelerated. Thus, the multiple components may be easily separated from each other in first layer 31. In FIG. 2A, first metal oxide film 81 may partially cover the surface of porous structure 80. In FIG. 2B, first metal oxide film 81 may partially cover the surface of substrate 10.

As shown in FIG. 2C, porous structure 80 of first layer 31 may include an aggregate of particles coated with first metal oxide film 81. In FIG. 2C, first layer 31 is constituted by an aggregate of particles each of which is coated with first metal oxide film 81. The particles include at least one kind selected from the group consisting of inorganic particles and polymer material particles, for example. First metal oxide film 81 may coat the entire surface of the particle or coat a part of the surface of the particle. When porous structure 80 includes an aggregate of particles coated with first metal oxide film 81, the interaction between the multiple components included in the sample and first layer 31 is accelerated. Thus, the multiple components may be easily separated from each other in first layer 31.

Whether each of the particles is coated with first metal oxide film 81 can be confirmed by observing the cross-section of first layer 31 with an electron microscope (for example, an electron scanning microscope). Whether each of the particles is coated with first metal oxide film 81 can also be confirmed by conducting an elemental analysis on the cross-section of first layer 31. The elemental analysis can be conducted by X-ray photoelectron spectroscopy (XPS) or energy dispersive X-ray spectroscopy (EDX), for example.

The thickness of first metal oxide film 81 is not particularly limited. The thickness of first metal oxide film 81 is determined according to the material of first metal oxide film 81, for example. There is a tendency that, as first metal oxide film 81 is thicker, the multiple components are more easily separated from each other in first layer 31 when the sample is developed. As first metal oxide film 81 is thicker, the mobility of the developing solvent in first layer 31 slows down. The thickness of first metal oxide film 81 ranges from 10 nm to 1000 nm both inclusive, for example.

First layer 31 may further include an additive. Examples of the additive include a fluorescence indicator and a binder.

Examples of the fluorescence indicator include magnesium tungstate and zinc silicate containing manganese. When first layer 31 includes the fluorescence indicator, positions of the multiple components can be detected by irradiating first layer 31 with ultraviolet ray.

The binder includes at least one selected from the group consisting of an inorganic binder, an organic fiber, a thickener, and an organic binder, for example. Examples of the inorganic binder include plaster and colloidal silica. Examples of the organic fiber include microfibrillar cellulose. Examples of the thickener include hydroxyethyl cellulose and carboxymethyl cellulose. Examples of the organic binder include polyvinyl alcohol and polyacrylic acid. When first layer 31 includes the binder, adhesiveness between substrate 10 and first layer 31 is improved. When the porous structure of first layer 31 is formed from an aggregate of inorganic particles or polymer material particles, durability of the aggregate of inorganic particles or polymer material particles is improved due to the binder.

The above-mentioned additives may be mixed into the material of the porous structure of first layer 31. The additives may coat the surfaces of inorganic particles or polymer material particles constituting the porous structure.

Second layer 32 has a porous structure. The porous structure of second layer 32 can carry the developing solvent from one end to the other end of second layer 32 in development direction X due to capillary force. The material of the porous structure of second layer 32 may be the same as any of those described as examples of the material of the porous structure of first layer 31. An average pore diameter of the porous structure of second layer 32 may range from 0.01 μm to 100 μm both inclusive. When the porous structure of second layer 32 is formed from an aggregate of inorganic particles or polymer material particles, an average particle diameter of inorganic particles or polymer material particles may range from 1 μm to 100 μm both inclusive.

Second layer 32 includes a second metal oxide. The second metal oxide is not particularly limited, as long as it is a metal oxide. The second metal oxide includes at least one selected from the group consisting of titanium oxide, aluminum oxide, tin oxide, zinc oxide, tungsten oxide, manganese oxide, nickel oxide, copper oxide, and magnesium oxide, for example. The second metal oxide may be a semimetal oxide. The semimetal oxide includes at least one selected from the group consisting of boron oxide and silicon dioxide, for example. The second metal oxide is different from the material of the porous structure of second layer 32. The composition of the second metal oxide is different from the composition of the porous structure of second layer 32. The second metal oxide may be included in the porous structure of second layer 32.

The second metal oxide is different from the first metal oxide. Specifically, an isoelectric point of the second metal oxide is different from an isoelectric point of the first metal oxide. A difference between the isoelectric point of the first metal oxide and the isoelectric point of the second metal oxide is 1 to 8, for example. The “isoelectric point” can be measured with the following method. Specifically, a water containing solvent and a metal oxide are brought into contact with each other. A zeta potential on the surface of the metal oxide is measured. The zeta potential can be measured by a commercially available zeta potential measurement device, for example. The pH value of the solvent when the zeta potential on the surface of the metal oxide becomes zero can be regarded as the isoelectric point of the metal oxide. The isoelectric point of the metal oxide is determined by the metal oxide. For example, the isoelectric point of tin oxide is typically 4.5 to 7.3. The isoelectric point of zinc oxide is typically 9.2. The isoelectric point of tungsten oxide is typically 0.5. The isoelectric point of nickel oxide is typically 10.3±0.4. The isoelectric point of magnesium oxide is typically 12.4±0.3. The isoelectric point of silicon dioxide is typically 1.8 to 2.2.

The second metal oxide may be in contact with a part of the porous structure of second layer 32. The second metal oxide may be disposed on the porous structure of second layer 32. The second metal oxide may be disposed between the porous structure of second layer 32 and substrate 10. When the porous structure of second layer 32 is formed from an aggregate of inorganic particles or polymer material particles, the second metal oxide may be located between multiple particles constituting the porous structure of second layer 32. A second metal oxide film may be disposed on the porous structure of second layer 32. The second metal oxide film is made of the second metal oxide. The second metal oxide film may partially cover the surface of the porous structure of second layer 32. The second metal oxide film may be disposed between the porous structure of second layer 32 and substrate 10. The second metal oxide film may partially cover the surface of substrate 10. When the second metal oxide is in contact with the porous structure of second layer 32, the interaction between the multiple components included in the sample and second layer 32 is accelerated. Thus, the multiple components may be easily separated from each other in second layer 32.

The porous structure of second layer 32 may include an aggregate of particles coated with the second metal oxide film. Second layer 32 may be formed from an aggregate of particles coated with the second metal oxide film. The particles include at least one kind selected from the group consisting of inorganic particles and polymer material particles, for example. The second metal oxide film may coat the entire surface of the particle or coat a part of the surface of the particle. When the porous structure includes an aggregate of particles coated with the second metal oxide film, the interaction between the multiple components included in the sample and second layer 32 is accelerated. Thus, the multiple components may be easily separated from each other in second layer 32.

The thickness of the second metal oxide film is not particularly limited. The thickness of the second metal oxide film is determined according to the material of the second metal oxide film, for example. There is a tendency that, as the second metal oxide film is thicker, the multiple components are more easily separated from each other in second layer 32 when the sample is developed. As the second metal oxide film is thicker, the mobility of the developing solvent in second layer 32 slows down. The thickness of the second metal oxide film ranges from 10 nm to 1000 nm both inclusive, for example.

Second layer 32 may further include any of the above-mentioned additives.

Length L1 of first layer 31 in development direction X is not particularly limited. Length L1 is determined according to the material of the porous structure of first layer 31, the first metal oxide, and a size of a container for housing TLC plate 100, for example. Length L1 ranges from 20 mm to 200 mm both inclusive, for example. The length of second layer 32 and the length of substrate 10 in development direction X are typically equal to length L1.

Length L2 of first layer 31 in array direction Y is not particularly limited. Length L2 is determined according to an amount of the sample to be placed on first layer 31, for example. Length L2 ranges from 10 mm to 100 mm both inclusive, for example.

Length L3 of second layer 32 in array direction Y is not particularly limited. Length L3 is equal to a value of length L2. The length of substrate 10 in development direction X is equal to the total of length L2 and length L3.

Thickness L4 of first layer 31 is not particularly limited. Thickness L4 is determined according to the porous structure of first layer 31, and the first metal oxide, for example. Thickness L4 ranges from 0.05 mm to 1 mm both inclusive, for example. The thickness of second layer 32 is typically equal to thickness L4 of first layer 31.

Thickness L5 of substrate 10 is not particularly limited as long as the shape of TLC plate 100 can be maintained. Thickness L5 ranges from 0.1 mm to 5 mm both inclusive, for example.

Next, a manufacturing method of TLC plate 100 will be described.

First, a first dispersion liquid containing inorganic particles or polymer material particles is prepared. The first dispersion liquid can be obtained by dispersing inorganic particles or polymer material particles into a coating solvent.

The coating solvent includes at least one selected from the group consisting of water and an organic solvent, for example. The organic solvent includes at least one selected from the group consisting of alcohol, ketone, ether, nitrile, sulfoxide, sulfone, ester, carboxylic acid, amide, hydrocarbon, aromatic hydrocarbon, and halogen-containing compound, for example. Examples of alcohol include methanol, ethanol, and isopropyl alcohol. Examples of ketone include acetone and ethyl methyl ketone. Examples of ether include tetrahydrofuran and dioxane. Examples of nitrile include acetonitrile. Examples of sulfoxide include dimethyl sulfoxide. Examples of sulfone include sulfolane. Examples of ester include ethyl acetate. Examples of carboxylic acid includes formic acid and acetic acid. Examples of amide include dimethylformamide. Examples of hydrocarbon include pentane and hexane. Examples of aromatic hydrocarbon include benzene, toluene, and xylene. Examples of halogen-containing compound include methylene chloride, chloroform, bromoform, chlorobenzene, and bromobenzene.

The first dispersion liquid is applied on a part of the surface of substrate 10 to form a coating film. The coating film is dried, whereby an untreated layer of first layer 31 is formed on substrate 10. The untreated layer of first layer 31 may be formed on substrate 10 by bonding filter paper or a porous body of polymer materials on a part of the surface of substrate 10 under pressure.

Then, a first metal oxide is deposited on the untreated layer of first layer 31. Thus, first layer 31 is formed on substrate 10. In this case, a first metal oxide film may be formed by the deposition of the first metal oxide on the untreated layer. Examples of a method for depositing the first metal oxide include sputtering using an existing mask, ion plating, electron beam evaporation, vacuum deposition, chemical vapor deposition, and chemical vapor deposition. In the manufacturing method in the present exemplary embodiment, the first metal oxide is deposited after the untreated layer of first layer 31 is formed, whereby first layer 31 is easily formed.

The first metal oxide may be deposited on substrate 10 in advance. In this case, the first metal oxide film may be formed by the deposition of the first metal oxide on substrate 10. The first dispersion liquid is applied on the deposited first metal oxide, and the obtained coating film is dried. Thus, first layer 31 is formed on substrate 10. First layer 31 may be formed on substrate 10 by bonding filter paper or a porous body of polymer materials on the first metal oxide under pressure.

The first dispersion liquid may include the first metal oxide. The first dispersion liquid may include particles coated with the first metal oxide film. Particles coated with the first metal oxide film can be manufactured by the following method, for example. A metal salt is dissolved in the first dispersion liquid. The metal salt is at least a salt of one metal selected from the group consisting of titanium, aluminum, tin, zinc, tungsten, manganese, nickel, copper, and magnesium, for example. When the metal salt is dissolved in the first dispersion liquid, a complex compound is generated. The complex compound adheres to the surfaces of the inorganic particles or polymer material particles. The inorganic particles or polymer material particles to which the complex compound adheres are treated such that metal oxides are deposited. The treatment includes, for example, changing pH of the first dispersion liquid or oxidation of the complex compound. The oxidation of the complex compound is conducted by heating the inorganic particles or polymer material particles, for example. Thus, particles coated with the first metal oxide film are obtained.

Then, a second dispersion liquid containing the inorganic particles or polymer material particles is prepared. The second dispersion liquid can be obtained by dispersing inorganic particles or polymer material particles into a coating solvent. The materials mentioned above can be used for the coating solvent.

The second dispersion liquid is applied on a part of the surface of substrate 10 to form a coating film. The coating film is dried, whereby an untreated layer of second layer 32 is formed on substrate 10. The untreated layer of second layer 32 may be formed on substrate 10 by bonding filter paper or a porous body of polymer materials on a part of the surface of substrate 10 under pressure.

Then, a second metal oxide is deposited on the untreated layer of second layer 32. Thus, second layer 32 is formed on substrate 10. In this case, a second metal oxide film may be formed by the deposition of the second metal oxide on the untreated layer. The methods mentioned above can be used for depositing the second metal oxide. In the manufacturing method in the present exemplary embodiment, the second metal oxide is deposited after the untreated layer of second layer 32 is formed, whereby second layer 32 is easily formed.

The second metal oxide may be deposited on substrate 10 in advance. In this case, the second metal oxide film may be formed by the deposition of the second metal oxide on substrate 10. The second dispersion liquid is applied on the deposited second metal oxide, and the obtained coating film is dried. Thus, second layer 32 is formed on substrate 10. Second layer 32 may be formed on substrate 10 by bonding filter paper or a porous body of polymer materials on the second metal oxide under pressure.

The second dispersion liquid may include the second metal oxide. The second dispersion liquid may include particles coated with the second metal oxide film. The above-mentioned methods for manufacturing particles coated with the first metal oxide film can be used as a method for manufacturing particles coated with the second metal oxide film, for example.

First layer 31 and second layer 32 may be formed by the following method. The first dispersion liquid is applied on the entire surface of substrate 10 to form a coating film. The coating film is dried, whereby an untreated layer of first layer 31 and an untreated layer of second layer 32 are formed on substrate 10. A first metal oxide is deposited on the untreated layer of first layer 31. A second metal oxide is deposited on the untreated layer of second layer 32. Thus, first layer 31 and second layer 32 are formed on substrate 10. The first metal oxide and the second metal oxide are deposited after the untreated layer of first layer 31 and the untreated layer of second layer 32 are formed, whereby separation layer 20 can be easily formed. In separation layer 20 formed by the above method, the side surface of first layer 31 is in contact with the side surface of second layer 32.

The order of formation of first layer 31 and second layer 32 on substrate 10 is not particularly limited. First layer 31 may be formed on substrate 10 after second layer 32 is formed on substrate 10.

Next, the sample analysis method using TLC plate 100 will be described.

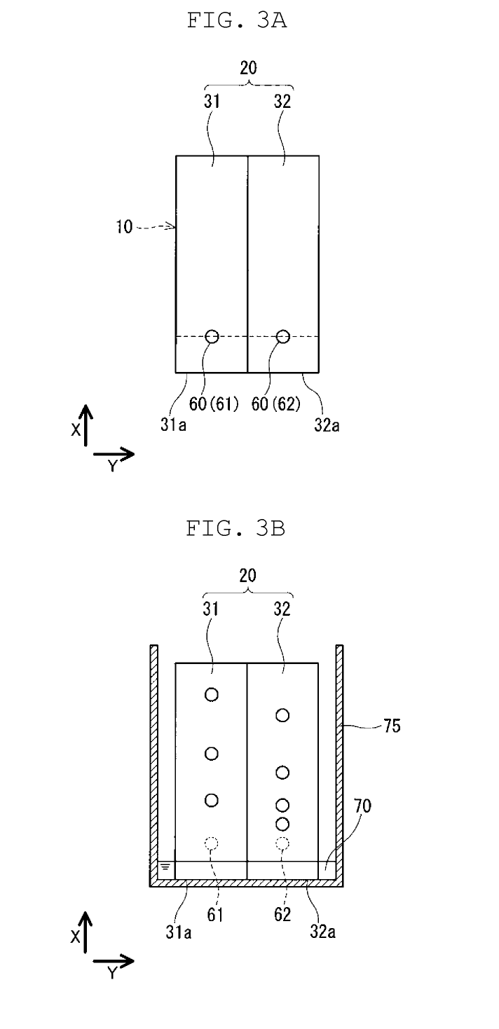

First, sample 60 is placed on each of first layer 31 and second layer 32 of separation layer 20 of TLC plate 100, as shown in FIG. 3A. When sample 60 is placed on first layer 31, sample 60 penetrates into first layer 31, so that circular spot 61 is formed. When sample 60 is placed on second layer 32, sample 60 penetrates into second layer 32, so that circular spot 62 is formed. Sample 60 is an aqueous solution containing a plurality of proteins, for example. The proportion of the plurality of proteins in sample 60 ranges from 0.01 wt. % to 1 wt. % both inclusive, for example. The volume of sample 60 placed on each of first layer 31 and second layer 32 ranges from 0.5 μL to 10 μL both inclusive, for example. The position where sample 60 is to be placed on each of first layer 31 and second layer 32 is not particularly limited, as long as sample 60 is not in direct contact with the developing solvent. An end of first layer 31 in development direction X is defined as end 31a, and an end of second layer 32 in development direction X is defined as end 32a. The distance from end 31a to the gravity center of spot 61 in development direction X may be equal to the distance from end 32a to the gravity center of spot 62 in development direction X.

Then, as shown in FIG. 3B, TLC plate 100 is placed in container 75 with end 31a of first layer 31 and end 32a of second layer 32 being directed downward. Container 75 contains developing solvent 70. Container 75 is a glass jar, for example. Container 75 may be installed inside an analyzing device (not shown).

Developing solvent 70 is not particularly limited, as long as it can proceed in first layer 31 or second layer 32 due to capillary force when being brought into contact with first layer 31 or second layer 32. Developing solvent 70 may contain water. When containing water, developing solvent 70 may contain water in a proportion ranging from 20 wt. % to 100 wt. % both inclusive. When developing solvent 70 contains water and sample 60 contains proteins, solubility of the proteins in developing solvent 70 is improved. Developing solvent 70 may contain an organic solvent. The materials mentioned above as examples of the coating solvent can be used as the organic solvent. The organic solvent contains at least one selected from the group consisting of methanol, ethanol, isopropyl alcohol, acetonitrile, and acetic acid, for example. When containing an organic solvent, developing solvent 70 may contain the organic solvent in a proportion ranging from 20 wt. % to 100 wt. % both inclusive. When developing solvent 70 contains carboxylic acid and sample 60 contains proteins, the frequency of absorption and desorption of proteins to and from each of the porous structure of first layer 31 and the porous structure of second layer 32 is improved. Developing solvent 70 may be an aqueous solution. A solute of the aqueous solution contains at least one selected from the group consisting of phosphate, citrate, acetate, and borate, for example.

When TLC plate 100 is placed in container 75, end 31a of first layer 31 and end 32a of second layer 32 are in contact with developing solvent 70. The liquid level of developing solvent 70 is set to prevent direct contact between developing solvent 70 and sample 60. Due to the capillary force, developing solvent 70 proceeds in development direction X from end 31a of first layer 31 and end 32a of second layer 32. When developing solvent 70 is brought into contact with sample 60, the multiple components included in sample 60 are dissolved into developing solvent 70. The multiple components dissolved in developing solvent 70 move in development direction X along with developing solvent 70. The multiple components located in spot 61 move while repeatedly adsorbed and desorbed to and from the porous structure of first layer 31. Since the frequency of adsorption and desorption varies according to each component, the multiple components are separated from each other in first layer 31. The multiple components located in spot 62 move while repeatedly adsorbed and desorbed to and from the porous structure of second layer 32. Since the frequency of adsorption and desorption varies according to each component, the multiple components are separated from each other in second layer 32.

A method for detecting positions of multiple components is not particularly limited, and any known methods can be employed. For example, when first layer 31 and second layer 32 contain a fluorescence indicator, separation layer 20 may be irradiated with ultraviolet ray to detect the positions of multiple components. In such a case, each of the multiple components can be a compound that absorbs ultraviolet ray. The analyzing device may have a mechanism for emitting ultraviolet ray. The positions of the multiple components may be detected by depositing a coloring reagent onto separation layer 20. In such a case, TLC plate 100 may be heated as necessary. Any known coloring reagent can be used. Examples of the coloring reagent include anisaldehyde, phosphomolybdic acid, iodine, ninhydrin, chameleon solution, 2,4dinitrophenylhydrazine, manganese chloride, and bromocresol green.

Under the same condition, the positions of the multiple components after sample 60 is developed are determined for each component. Therefore, with the sample analysis method according to the present exemplary embodiment, each of the separated multiple components can be identified. For example, a component having a known structure is developed on TLC plate 100 under the condition same as the condition for developing sample 60. Data in which the position of the component after the development and the structure of the component are associated with each other is acquired. This data may be stored in a memory of the analyzing device in advance. Through comparison with the data, each of the multiple components can be identified based on the position of each component after sample 60 is developed.

In TLC plate 100, the isoelectric point of the first metal oxide included in first layer 31 is different from the isoelectric point of the second metal oxide included in second layer 32. Specifically, the interaction between the multiple components included in sample 60 and first layer 31 is different from the interaction between the multiple components and second layer 32. Therefore, when the multiple components are developed in first layer 31 and second layer 32, different results can be obtained in first layer 31 and second layer 32. For example, the multiple components which are not separated from each other in first layer 31 are separated from each other in second layer 32. The multiple components which are not separated from each other in second layer 32 are separated from each other in first layer 31. Each of the multiple components can be identified based on the development result of the multiple components in a first stage. Therefore, it is unnecessary to develop the multiple components in a second stage. Thus, sample 60 can be analyzed more easily and more quickly.

When developing solvent 70 contains water, the first metal oxide and the second metal oxide are charged due to contact with developing solvent 70. Specifically, when the pH of developing solvent 70 is smaller than the isoelectric point of the metal oxide, the metal oxide is positively charged. When the pH of developing solvent 70 is greater than the isoelectric point of the metal oxide, the metal oxide is negatively charged. The isoelectric point of the first metal oxide and the isoelectric point of the second metal oxide are different from each other, and thus, types or amounts of charges generated in the first metal oxide and the second metal oxide differ from each other. Accordingly, the interaction between the multiple components and first layer 31 greatly differs from the interaction between the multiple components and second layer 32. Thus, each of the multiple components can be identified based on the development result of the multiple components in the first stage.

When sample 60 contains a protein, the interaction between first layer 31 or second layer 32 and the protein may be accelerated. Specifically, a specific functional group contained in the protein may be coordinated to the first metal oxide or the second metal oxide. For example, when the protein has a phosphate group, the phosphate group is coordinated to titanium oxide. When the protein has a sugar chain, the sugar chain is coordinated to boron oxide. Therefore, when a metal oxide to which a specific functional group included in the protein can be coordinated is selected as the first metal oxide or the second metal oxide, the multiple components can be easily separated from each other in first layer 31 or second layer 32.

Depending on the multiple components included in sample 60, first layer 31 may not include the first metal oxide. Similarly, second layer 32 may not include the second metal oxide. In such a case, TLC plate 100 needs to satisfy at least one requirement selected from among the requirement in which the composition of first layer 31 is different from the composition of second layer 32 and the requirement in which the structure of first layer 31 is different from the structure of second layer 32. When the above requirement is satisfied, the interaction between the multiple components included in sample 60 and first layer 31 is different from the interaction between the multiple components and second layer 32. Therefore, when the multiple components are developed in first layer 31 and second layer 32, different results can be obtained in first layer 31 and second layer 32. “The structure of first layer 31 being different from the structure of second layer 32” means that at least one selected from among an average pore diameter of the porous structure of first layer 31, a void ratio of the porous structure, and an average particle diameter of the material of the porous structure is different from that of the porous structure of second layer 32, for example.

TLC plate 100 described in the above first exemplary embodiment may be configured such that only second layer 32, among first layer 31 and second layer 32, has the porous structure modified with a metal oxide. With this configuration, the zeta potential of first layer 31 and the zeta potential of second layer 32 can be different from each other.

That is, first layer 31 does not have a metal oxide film. First layer 31 may have a porous structure. The porous structure of first layer 31 may include an aggregate of particles each having a single phase composition, i.e., may be constituted by an aggregate of particles each having a single phase composition. A “particle having a single composition phase” indicates a particle which is uniform in composition. In other words, this means that the particle is not coated with a metal oxide film.

Meanwhile, the porous structure of second layer 32 is modified with a metal oxide film. The “porous structure being modified with a metal oxide film” means that the porous structure is coated with a metal oxide film or the surfaces of particles constituting the porous structure are coated with the metal oxide film. That is, second layer 32 has a metal oxide film. The metal oxide film is made of a metal oxide. The metal oxide includes at least one selected from the group consisting of titanium oxide, aluminum oxide, tin oxide, zinc oxide, tungsten oxide, manganese oxide, nickel oxide, copper oxide, and magnesium oxide, for example. The metal oxide may be a semimetal oxide. The semimetal oxide includes at least one selected from the group consisting of boron oxide and silicon dioxide, for example. The material of the metal oxide film is different from the material of the porous structure of second layer 32. The composition of the metal oxide film is different from the composition of the porous structure of second layer 32.

In TLC plate 100 having the above structure, only second layer 32, among first layer 31 and second layer 32, has the porous structure modified with the metal oxide film. Specifically, the interaction between the multiple components included in sample 60 and first layer 31 is different from the interaction between the multiple components and second layer 32. Therefore, when the multiple components are developed in first layer 31 and second layer 32, different results can be obtained in first layer 31 and second layer 32. For example, the multiple components which are not separated from each other in first layer 31 are separated from each other in second layer 32. The multiple components which are not separated from each other in second layer 32 are separated from each other in first layer 31. Each of the multiple components can be identified based on the development result of the multiple components in a first stage. Therefore, it is unnecessary to develop the multiple components in a second stage. Thus, sample 60 can be analyzed more easily and more quickly.

### Second Exemplary Embodiment

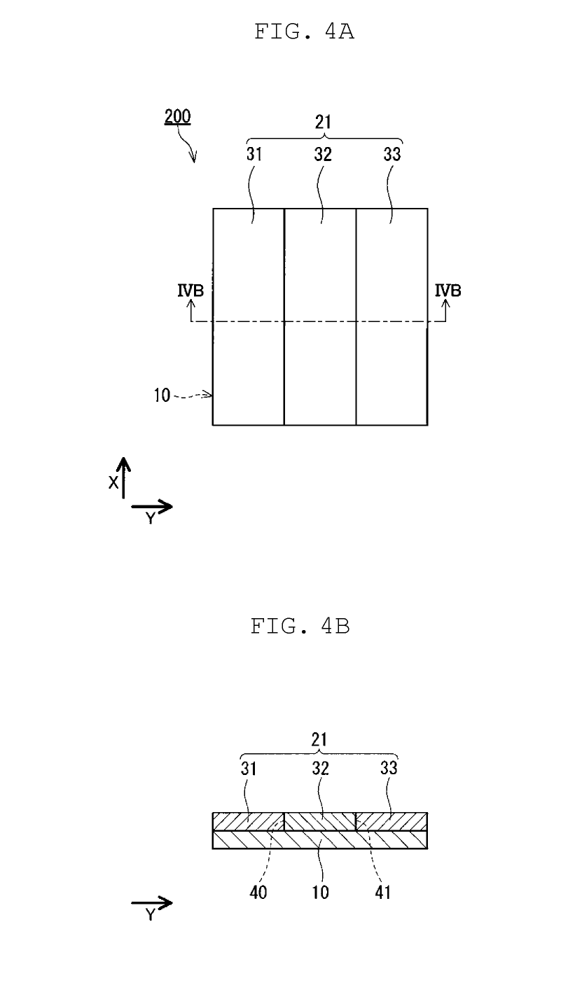

As shown in FIGS. 4A and 4B, TLC plate 200 according to the present exemplary embodiment includes separation layer 21 having first layer 31, second layer 32, and third layer 33. The structure of TLC plate 200 is the same as the structure of TLC plate 100 according to the first exemplary embodiment except for third layer 33. Therefore, constituent elements which are common between TLC plate 100 in the first exemplary embodiment and TLC plate 200 in the present exemplary embodiment are denoted by the same reference marks and may not be described in detail below. That is, the descriptions regarding the following exemplary embodiments are mutually applicable, in so far as they are technically consistent with one another. In addition, the respective exemplary embodiments may be combined with one another, in so far as they are technically consistent with one another.

Third layer 33 is a layer having a band shape. Third layer 33 has a rectangular band shape in a plan view. Third layer 33 extends in development direction X. Third layer 33 extends from one of a pair of end faces of substrate 10 to the other in development direction X. Note that third layer 33 may not reach to the other end face of substrate 10.

In the present exemplary embodiment, first layer 31, second layer 32, and third layer 33 are disposed on substrate 10. In other words, first layer 31, second layer 32, and third layer 33 are in contact with substrate 10. First layer 31, second layer 32, and third layer 33 are arrayed in this order in array direction Y. Third layer 33 is in contact with second layer 32. A side surface of third layer 33 and a side surface of second layer 32 are in contact with each other. When separation layer 21 is viewed in a plan view, one side of third layer 33 is in contact with one side of second layer 32. A length of the one side of third layer 33 is equal to a length of the one side of second layer 32. Boundary face 41 is formed due to the contact between second layer 32 and third layer 33. Boundary face 41 extends in development direction X. Note that third layer 33 may not be in contact with second layer 32.

Third layer 33 has a porous structure. The porous structure of third layer 33 can carry the developing solvent from one end to the other end of third layer 33 in development direction X due to capillary force. The material of the porous structure of third layer 33 may be the same as any of those described as examples of the material of the porous structure of first layer 31. An average pore diameter of the porous structure of third layer 33 may range from 0.01 μm to 100 μm both inclusive. When the porous structure of third layer 33 is formed from an aggregate of inorganic particles or polymer material particles, an average particle diameter of inorganic particles or polymer material particles may range from 1 μm to 100 μm both inclusive.

Third layer 33 includes a third metal oxide. The third metal oxide may be the same as any of those described as examples of the first metal oxide. The third metal oxide is different from the material of the porous structure of third layer 33. The composition of the third metal oxide is different from the composition of the porous structure of third layer 33. The third metal oxide may be included in the porous structure of third layer 33. An isoelectric point of the first metal oxide, an isoelectric point of the second metal oxide, and an isoelectric point of the third metal oxide are different from one another. For example, a difference between the isoelectric point of the third metal oxide and the isoelectric point of the first metal oxide and a difference between the isoelectric point of the third metal oxide and the isoelectric point of the second metal oxide are 1 to 8, respectively.

The third metal oxide may be in contact with a part of the porous structure of third layer 33. The third metal oxide may be disposed on the porous structure of third layer 33. The third metal oxide may be disposed between the porous structure of third layer 33 and substrate 10. When the porous structure of third layer 33 is formed from an aggregate of inorganic particles or polymer material particles, the third metal oxide may be located between multiple particles constituting the porous structure of third layer 33. The third metal oxide film may be disposed on the porous structure of third layer 33. The third metal oxide film is made of the third metal oxide. The third metal oxide film may partially cover the surface of the porous structure of third layer 33. The third metal oxide film may be disposed between the porous structure of third layer 33 and substrate 10. The third metal oxide film may partially cover the surface of substrate 10. When the third metal oxide is in contact with the porous structure of third layer 33, an interaction between the multiple components included in sample 60 and third layer 33 is accelerated. Thus, the multiple components may be easily separated from each other in third layer 33.

The porous structure of third layer 33 may include an aggregate of particles coated with the third metal oxide film. Third layer 33 may be formed from an aggregate of particles each of which is coated with the third metal oxide film. The particles include at least one kind selected from the group consisting of inorganic particles and polymer material particles, for example. The third metal oxide film may coat the entire surface of the particle or coat a part of the surface of the particle. When the porous structure includes an aggregate of particles coated with the third metal oxide film, the interaction between the multiple components included in sample 60 and third layer 33 is accelerated. Thus, the multiple components may be easily separated from each other in third layer 33.

The thickness of the third metal oxide film is not particularly limited. The thickness of the third metal oxide film is determined according to the material of the third metal oxide film. There is a tendency that, as the third metal oxide film is thicker, the multiple components are more easily separated from each other in third layer 33 when the sample is developed. As the third metal oxide film is thicker, the mobility of the developing solvent in third layer 33 slows down. The thickness of the third metal oxide film ranges from 10 nm to 1000 nm both inclusive, for example.

Third layer 33 may further include any of the additives mentioned above.

The length of third layer 33 in development direction X is typically equal to length L1 of first layer 31 of TLC plate 100. The length of third layer 33 in array direction Y is typically equal to length L2 of first layer 31 of TLC plate 100.

As a method for forming third layer 33 on substrate 10, the methods described above as examples of the method for forming first layer 31 and second layer 32 on substrate 10 in the first exemplary embodiment can be used, for example.

In TLC plate 200, the isoelectric point of the first metal oxide, the isoelectric point of the second metal oxide, and the isoelectric point of the third metal oxide are different from one another. Therefore, when the multiple components are developed in first layer 31, second layer 32, and third layer 33, different results can be obtained in first layer 31, second layer 32, and third layer 33. For example, the multiple components which are not separated from each other in first layer 31 and second layer 32 are separated from each other in third layer 33. Each of the multiple components can be identified based on the development result of the multiple components in a first stage. Therefore, it is unnecessary to develop the multiple components in a second stage. Thus, sample 60 can be analyzed more easily and more quickly.

Depending on the multiple components included in sample 60, third layer 33 may not include the third metal oxide. In such a case, TLC plate 200 needs to satisfy at least one requirement selected from among the requirement in which first layer 31, second layer 32, and third layer 33 are different in composition and the requirement in which first layer 31, second layer 32, and third layer 33 are different in structure. When the above requirement is satisfied, first layer 31, second layer 32, and third layer 33 induce different interactions with the multiple components included in sample 60. Therefore, when the multiple components are developed in first layer 31, second layer 32, and third layer 33, different results can be obtained in first layer 31, second layer 32, and third layer 33. “First layer 31, second layer 32, and third layer 33 being different in structure” means that first layer 31, second layer 32, and third layer 33 are different in at least one factor selected from among an average pore diameter of the porous structure, a void ratio of the porous structure, and an average particle diameter of the material of the porous structure, for example.

TLC plate 200 described in the above second exemplary embodiment may be configured such that first layer 31 does not have a metal oxide film as in the first exemplary embodiment. With this configuration, the effect same as the effect of the first exemplary embodiment can be obtained.

### Third Exemplary Embodiment

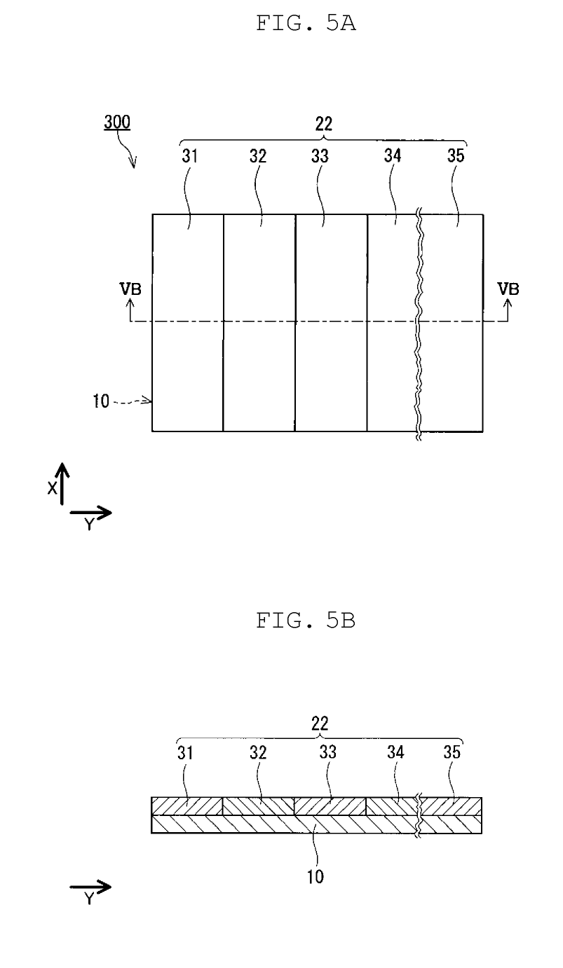

As shown in FIGS. 5A and 5B, TLC plate 300 according to the present exemplary embodiment is obtained by further providing fourth layer 34 to n-th layer 35 to the configuration of TLC plate 200 in the second exemplary embodiment. Each of fourth layer 34 to n-th layer 35 induces an interaction different from the interactions induced by first layer 31, second layer 32, and third layer 33, with respect to multiple components included in sample 60. Therefore, when the multiple components are developed in first layer 31 to n-th layer 35, different results can be obtained in first layer 31 to n-th layer 35. For example, the multiple components which are not separated from each other in first layer 31, second layer 32, and third layer 33 are separated from each other in any one of fourth layer 34 to n-th layer 35.

Each of fourth layer 34 to n-th layer 35 is a layer having a band shape. Each of fourth layer 34 to n-th layer 35 has a rectangular band shape in a plan view. n is an integer equal to or greater than 4. n is an integer from 5 to 10, for example. Each of fourth layer 34 to n-th layer 35 extends in development direction X. Each of fourth layer 34 to n-th layer 35 extends from one of a pair of end faces of substrate 10 to the other in development direction X. Note that each of fourth layer 34 to n-th layer 35 may not reach to the other end face of substrate 10.

In the present exemplary embodiment, first layer 31 to n-th layer 35 are disposed on substrate 10. In other words, first layer 31 to n-th layer 35 are in contact with substrate 10. First layer 31 to n-th layer 35 are arrayed in this order in array direction Y. Each of fourth layer 34 to n-th layer 35 is in contact with the corresponding one of third layer 33 to (n−1)th layer (not shown). When separation layer 22 is viewed in a plan view, one side of each of fourth layer 34 to n-th layer 35 is in contact with one side of the corresponding one of third layer 33 to (n−1)th layer. A length of the one side of each of fourth layer 34 to n-th layer 35 is equal to a length of the one side of the corresponding one of third layer 33 to (n−1)th layer. Note that each of fourth layer 34 to n-th layer 35 may not be in contact with the corresponding one of third layer 33 to (n−1)th layer.

Each of fourth layer 34 to n-th layer 35 has a porous structure. The porous structure of each of fourth layer 34 to n-th layer 35 can carry the developing solvent from one end to the other end of each of fourth layer 34 to n-th layer 35 in development direction X due to capillary force. The material of the porous structure of each of fourth layer 34 to n-th layer 35 may be the same as any of those described above as examples of the porous structure of first layer 31. An average pore diameter of the porous structure of each of fourth layer 34 to n-th layer 35 may range from 0.01 μm to 100 μm both inclusive. When the porous structure of each of fourth layer 34 to n-th layer 35 is formed from an aggregate of inorganic particles or polymer material particles, an average particle diameter of inorganic particles or polymer material particles may range from 1 μm to 100 μm both inclusive.

Each of fourth layer 34 to n-th layer 35 includes a corresponding one of a fourth metal oxide to an n-th metal oxide. Each of the fourth metal oxide to the n-th metal oxide may be the same as any of those described as examples of the first metal oxide. Each of the fourth metal oxide to the n-th metal oxide is different from the material of the porous structure of the corresponding one of fourth layer 34 to n-th layer 35. The composition of each of the fourth metal oxide to the n-th metal oxide is different from the composition of the porous structure of the corresponding one of fourth layer 34 to n-th layer 35. Each of the fourth metal oxide to the n-th metal oxide may be included in the porous structure of the corresponding one of fourth layer 34 to n-th layer 35. The first metal oxide to the n-th metal oxide are different in isoelectric point.

Each of the fourth metal oxide to the n-th metal oxide may be in contact with a part of the porous structure of the corresponding one of fourth layer 34 to n-th layer 35. Each of the fourth metal oxide to the n-th metal oxide may be disposed on the porous structure of the corresponding one of fourth layer 34 to n-th layer 35. Each of the fourth metal oxide to the n-th metal oxide may be disposed between the porous structure of the corresponding one of fourth layer 34 to n-th layer 35 and substrate 10. When the porous structures of fourth layer 34 to n-th layer 35 are formed from an aggregate of inorganic particles or polymer material particles, each of the fourth metal oxide to the n-th metal oxide may be located between multiple particles constituting the porous structure of the corresponding one of fourth layer 34 to n-th layer 35. Each of the fourth metal oxide film to the n-th metal oxide film may be disposed on the porous structure of the corresponding one of fourth layer 34 to n-th layer 35. Each of the fourth metal oxide film to the n-th metal oxide film is made of the corresponding one of the fourth metal oxide to the n-th metal oxide. Each of the fourth metal oxide film to the n-th metal oxide film may partially cover the surface of the porous structure of the corresponding one of fourth layer 34 to n-th layer 35. Each of the fourth metal oxide film to the n-th metal oxide film may be disposed between substrate 10 and the porous structure of the corresponding one of fourth layer 34 to n-th layer 35. Each of the fourth metal oxide film to the n-th metal oxide film may partially cover the surface of substrate 10. When each of the fourth metal oxide to the n-th metal oxide is in contact with the porous structure of the corresponding one of fourth layer 34 to n-th layer 35, the interaction between the multiple components included in sample 60 and each of fourth layer 34 to n-th layer 35 is accelerated. Thus, the multiple components may be easily separated from each other in each of fourth layer 34 to n-th layer 35.

The porous structure of each of fourth layer 34 to n-th layer 35 may include an aggregate of particles coated with the corresponding one of the fourth metal oxide film to the n-th metal oxide film. Each of fourth layer 34 to n-th layer 35 may be constituted by an aggregate of particles each of which is coated with the corresponding one of the fourth metal oxide film to the n-th metal oxide film. The particles include at least one kind selected from the group consisting of inorganic particles and polymer material particles, for example. The fourth metal oxide film to the n-th metal oxide film may coat the entire surfaces of the particles or coat a part of the surfaces of the particles. When the porous structure of each of fourth layer 34 to n-th layer 35 includes an aggregate of particles coated with the corresponding one of the fourth metal oxide film to the n-th metal oxide film, the interaction between the multiple components included in sample 60 and each of fourth layer 34 to n-th layer 35 is accelerated. Thus, the multiple components may be easily separated from each other in each of fourth layer 34 to n-th layer 35.

The thickness of each of the fourth metal oxide film to the n-th metal oxide film is not particularly limited. The thickness of each of the fourth metal oxide film to the n-th metal oxide film is determined according to the material of the corresponding one of the fourth metal oxide film to the n-th metal oxide film. There is a tendency that, as each of the fourth metal oxide film to the n-th metal oxide film is thicker, the multiple components are more easily separated from each other when the sample is developed in development direction X. As each of the fourth metal oxide film to the n-th metal oxide film is thicker, the mobility of the developing solvent in each of fourth layer 34 to n-th layer 35 slows down. The thickness of each of the fourth metal oxide film to the n-th metal oxide film ranges from 10 nm to 1000 nm both inclusive, for example.

Fourth layer 34 to n-th layer 35 may further include any of the additives mentioned above.

The length of each of fourth layer 34 to n-th layer 35 in development direction X is typically equal to length L1 of first layer 31 of TLC plate 100. The length of each of fourth layer 34 to n-th layer 35 in array direction Y is typically equal to length L2 of first layer 31 of TLC plate 100.

As a method for forming each of fourth layer 34 to n-th layer 35 on substrate 10, the methods described above as examples of the method for forming first layer 31 and second layer 32 on substrate 10 in the first exemplary embodiment can be used, for example.

In TLC plate 300, the first metal oxide to the n-th metal oxide are different in isoelectric point. Therefore, when the multiple components are developed in first layer 31 to n-th layer 35, different results can be obtained in first layer 31 to n-th layer 35. For example, the multiple components which are not separated from each other in first layer 31, second layer 32, and third layer 33 are separated from each other in any one of fourth layer 34 to n-th layer 35. Each of the multiple components can be identified based on the development result of the multiple components in a first stage. Therefore, it is unnecessary to develop the multiple components in a second stage. Thus, sample 60 can be analyzed more easily and more quickly.

Depending on the multiple components included in sample 60, each of fourth layer 34 to n-th layer 35 may not include the corresponding one of the fourth metal oxide to the n-th metal oxide. In such a case, TLC plate 300 needs to satisfy at least one requirement selected from among the requirement in which first layer 31 to n-th layer 35 are different in composition and the requirement in which first layer 31 to n-th layer 35 are different in structure. When the above requirement is satisfied, first layer 31 to n-th layer 35 induce different interactions with the multiple components included in sample 60. Therefore, when the multiple components are developed in first layer 31 to n-th layer 35, different results can be obtained in first layer 31 to n-th layer 35. “First layer 31 to n-th layer 35 being different in structure” means that first layer 31 to n-th layer 35 are different in at least one factor selected from among an average pore diameter of the porous structure, a void ratio of the porous structure, and an average particle diameter of the material of the porous structure, for example.

TLC plate 300 described in the above third exemplary embodiment may be configured such that first layer 31 does not have a metal oxide film as in the first exemplary embodiment. With this configuration, the effect same as the effect of the first exemplary embodiment can be obtained.

### Fourth Exemplary Embodiment

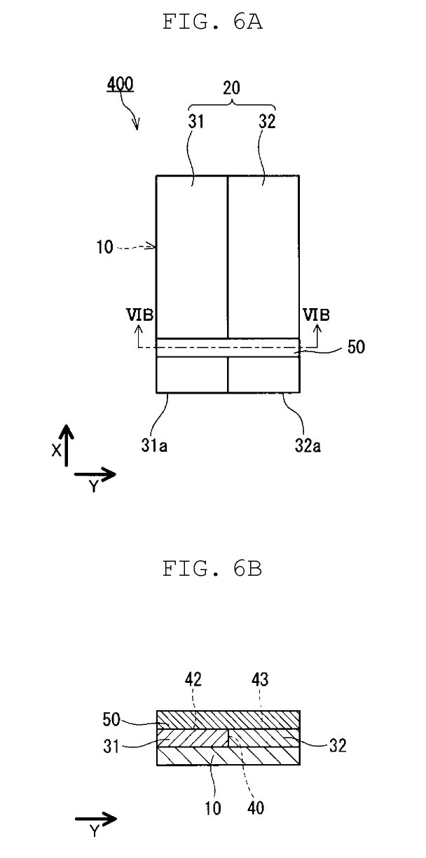

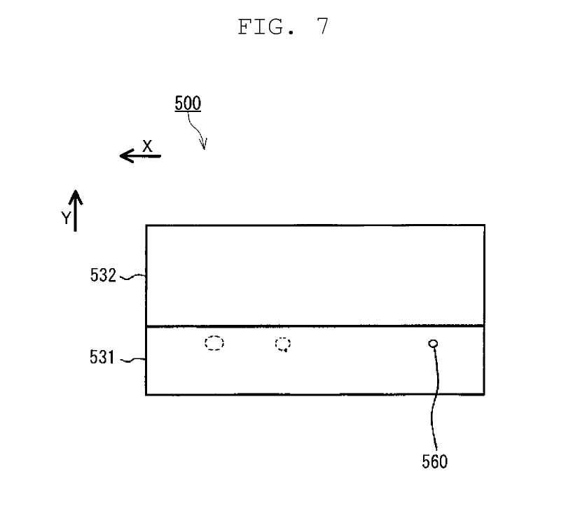

As shown in FIGS. 6A and 6B, TLC plate 400 according to the present exemplary embodiment includes functional layer 50 disposed on separation layer 20. The structure of TLC plate 400 is the same as the structure of TLC plate 100 in the first exemplary embodiment except for functional layer 50. When sample 60 is placed on functional layer 50, sample 60 penetrates into functional layer 50. Sample 60 spreads all over functional layer 50. Sample 60 penetrating into functional layer 50 is brought into contact with separation layer 20. Therefore, it is unnecessary to place sample 60 on separation layer 20 several times. Thus, sample 60 can be efficiently placed on separation layer 20.

Functional layer 50 is a layer having a band shape. Functional layer 50 has a rectangular band shape in a plan view. Functional layer 50 is in contact with first layer 31 and second layer 32. Functional layer 50 extends in array direction Y. Functional layer 50 extends from one of a pair of end faces of substrate 10 to the other in array direction Y. Note that functional layer 50 may not extend from the one end face of substrate 10, as long as it is in contact with first layer 31 and second layer 32. Functional layer 50 may not reach to the other end face of substrate 10.

Functional layer 50 is disposed on first layer 31 and second layer 32. A lower surface of functional layer 50 and an upper surface of first layer 31 constitute boundary face 42. The lower surface of functional layer 50 and an upper surface of second layer 32 constitute boundary face 43. Boundary faces 42 and 43 extend in array direction Y.

Functional layer 50 has a porous structure. The material of the porous structure of functional layer 50 may be the same as any of those described as examples of the porous structure of first layer 31. An average pore diameter of the porous structure of functional layer 50 may range from 0.01 μm to 100 μm both inclusive. When the porous structure of functional layer 50 is formed from an aggregate of inorganic particles or polymer material particles, an average particle diameter of inorganic particles or polymer material particles may range from 1 μm to 100 μm both inclusive. Functional layer 50 may further include any of the additives mentioned above.

The distance from end 31a of first layer 31 to functional layer 50 in development direction X is determined according to the liquid level of developing solvent 70, for example. The length of functional layer 50 in development direction X is determined according to an amount of sample 60 to be placed on functional layer 50, for example. The thickness of functional layer 50 is determined according to the porous structure of functional layer 50, for example. The thickness of functional layer 50 is typically equal to thickness L4 of first layer 31.

As a method for forming functional layer 50 on separation layer 20, the methods described above as examples of the method for forming first layer 31 and second layer 32 on substrate 10 in the first exemplary embodiment can be used, for example.

Functional layer 50 has a porous structure. Therefore, when sample 60 is placed on functional layer 50, sample 60 penetrates into functional layer 50. Sample 60 spreads all over functional layer 50. Sample 60 penetrating into functional layer 50 is brought into contact with separation layer 20. Specifically, sample 60 penetrating into functional layer 50 is brought into contact with first layer 31 via boundary face 42. Thus, sample 60 penetrates into first layer 31. Sample 60 penetrating into functional layer 50 is brought into contact with second layer 32 via boundary face 43. Thus, sample 60 penetrates into second layer 32. Since sample 60 spreads all over functional layer 50, it is unnecessary to place sample 60 on separation layer 20 several times. Thus, sample 60 can be efficiently placed on separation layer 20. The volume of sample 60 to be placed on functional layer 50 ranges from 2 μL to 20 μL both inclusive, for example.

TLC plate 400 described in the above fourth exemplary embodiment may be configured such that first layer 31 does not have a metal oxide film as in the first exemplary embodiment. With this configuration, the effect same as the effect of the first exemplary embodiment can be obtained.

### INDUSTRIAL APPLICABILITY

The technique disclosed in the present specification is useful for protein analysis or the like.

### REFERENCE MARKS IN THE DRAWINGS

10: substrate
20, 21, 22: separation layer
31: first layer
32: second layer
50: functional layer
60: sample
100, 200, 300, 400: TLC plate (thin layer chromatography plate)
X: development direction (first direction)
y: array direction (second direction)

1. A thin layer chromatography plate comprising:
a substrate; and
a separation layer disposed on the substrate, the separation layer configured to separate multiple components included in a sample from each other, wherein:
the separation layer includes a first layer extending in a first direction and a second layer extending in the first direction, the first layer and the second layer each having a porous structure,
the first layer and the second layer are arrayed in a second direction orthogonal to the first direction, and
a zeta potential of the first layer is different from a zeta potential of the second layer.

2. The thin layer chromatography plate according to claim 1, wherein:
the first layer includes a first metal oxide,
the second layer includes a second metal oxide, and
an isoelectric point of the first metal oxide is different from an isoelectric point of the second metal oxide.

3. The thin layer chromatography plate according to claim 1, wherein only the second layer among the first layer and the second layer has the porous structure modified with a metal oxide.

4. The thin layer chromatography plate according to claim 2, wherein the first metal oxide is disposed on the porous structure of the first layer.

5. The thin layer chromatography plate according to claim 2, wherein:
the first layer includes a first metal oxide film disposed on the porous structure of the first layer, and
the first metal oxide film is made of the first metal oxide.

6. The thin layer chromatography plate according to claim 2, wherein:
the porous structure of the first layer includes an aggregate of particles, the particles being coated with a first metal oxide film, and
the first metal oxide film is made of the first metal oxide.

7. The thin layer chromatography plate according to claim 2, wherein the second metal oxide is disposed on the porous structure of the second layer.

8. The thin layer chromatography plate according to claim 2, wherein:
the second layer includes a second metal oxide film disposed on the porous structure of the second layer, and
the second metal oxide film is made of the second metal oxide.

9. The thin layer chromatography plate according to claim 2, wherein:
the porous structure of the second layer includes an aggregate of particles, the particles being coated with a second metal oxide film, and
the second metal oxide film is made of the second metal oxide.

10. The thin layer chromatography plate according to claim 3, wherein the porous structure of the first layer includes an aggregate of particles, the particles each having a single composition phase.

11. The thin layer chromatography plate according to claim 2, wherein the first metal oxide includes at least one selected from a group consisting of titanium oxide, aluminum oxide, tin oxide, zinc oxide, tungsten oxide, manganese oxide, nickel oxide, copper oxide, and magnesium oxide.

12. The thin layer chromatography plate according to claim 2, wherein the second metal oxide includes at least one selected from the group consisting of titanium oxide, aluminum oxide, tin oxide, zinc oxide, tungsten oxide, manganese oxide, nickel oxide, copper oxide, and magnesium oxide.

13. The thin layer chromatography plate according to claim 2, wherein the second layer is in contact with the first layer.

14. The thin layer chromatography plate according to claim 2, further comprising a functional layer having a band shape, the functional layer being disposed on the separation layer for placement of the sample above the separation layer, wherein the functional layer extends in the second direction.

15. A sample analysis method comprising:
placing a sample onto each of the first layer and the second layer of the thin layer chromatography plate according to claim 1; and
bringing each of ends of the first layer and the second layer in the first direction into contact with a developing solvent.

16. The sample analysis method according to claim 15, wherein the developing solvent contains water.

17. The sample analysis method according to claim 15, wherein the developing solvent contains a protein.
